(19) United States
(12) Patent Application Publication
(10) Pub. No.: US 2025/0027903 A1
(43) Pub. Date: Jan. 23, 2025

(54) BUBBLE, BUBBLE AGGREGATE, BUBBLE WATER, BUBBLE CONTROL DEVICE, AND BUBBLE CONTROL METHOD

(71) Applicant: Panasonic Intellectual Property Management Co., Ltd., Osaka (JP)

(72) Inventors: Hidetaka SUGAYA, Shiga (JP); Katsutoshi FUKUDA, Kyoto (JP)

(73) Assignee: Panasonic Intellectual Property Management Co., Ltd., Osaka (JP)

(21) Appl. No.: 18/908,265

(22) Filed: Oct. 7, 2024

Related U.S. Application Data
(63) Continuation of application No. PCT/JP2023/014249, filed on Apr. 6, 2023.

(30) Foreign Application Priority Data
Apr. 18, 2022 (JP) 2022-068423

(51) Int. Cl. G01N 27/447

(52) U.S. Cl. CPC G01N 27/44752

(57) ABSTRACT

When an electric field reversal test is performed using water (W1) containing bubbles (10), in which the bubbles (10) are alternately attracted to an anode and a cathode, the bubbles (10) exhibit a behavior in which the bubbles (10) have charges of opposite signs between a slow filed reversal and a fast field reversal in which the electric field is reversed in a shorter period than in the slow field reversal.

### TECHNICAL FIELD

The present disclosure relates to a bubble, a bubble aggregate, bubble water, bubble control device, and a bubble control method that are used in a variety of applications.

### BACKGROUND ART

Recent years have witnessed liquids containing microbubbles, micro-nano bubbles, nanobubbles, etc., having a diameter of 10 μm or less, for example, being used in a variety of applications such as cleaning, sterilization, and deodorization.

These tiny bubbles have a higher internal pressure than bubbles with a larger diameter, so they can remain in water for a longer time (from a few hours to a few weeks) without popping right away, and only pop after going through the processes of “rising,” “contracting,” and “collapsing.”

In these processes, the microbubbles and the like provide various effects, such as cleaning, sterilization, and deodorization.

For instance, the following Non-Patent Literature 1 discloses a reported example of positively charged bubbles, in which the zeta potential can be made positive at a pH of less than 4 through chemical adjustment.

Also, the following Non-Patent Literature 2 discloses that bubbles are generated by putting water in a container and shaking it from side to side, and that these bubbles are all negatively charged.

### CITATION LIST

### Non-Patent Literature

Non-Patent Literature 1: Soft Matter, 2018, 14, 9643-9656
Non-Patent Literature 2: Langmuir 2020, 36, 2264-2270

### SUMMARY

### Technical Problem

However, the following problems are encountered with the above-mentioned conventional bubbles.

With the bubbles disclosed in the above-mentioned Non-Patent Literature 1, it is disclosed that a chemical substance such as a surfactant is added to switch the sign of the zeta potential of the negatively charged bubbles in order to change the responsiveness of the charged bubbles. Therefore, a chemical substance has to be added in order to change the responsiveness of the charged bubbles, but a problem is that this may damage the components of the water containing the bubbles, so this narrows the range of applications.

It is an object of the present disclosure to provide bubbles, a bubble aggregate, bubble water, a bubble control device, and a bubble control method with which the responsiveness of electrically charged bubbles can be switched without having to add any chemical substances or the like.

### Solution to Problem

When an electric field reversal test is performed using water containing the bubble, in which the bubble is alternately attracted to an anode and a cathode, the bubble of the present disclosure behaves as if they have charges of the opposite sign between slow field reversal and fast field reversal in which the electric field is reversed at a shorter period than in slow field reversal.

Also, the bubble of the present disclosure has an electrostatic property that can reverse charge by switching the frequency of the electric field reversal using water containing the bubble.

### Effects

With the bubbles of the present disclosure, the responsiveness of the charged bubbles can be switched without having to add any chemical substances or the like.

### BRIEF DESCRIPTION OF THE DRAWINGS

FIG. 1 is a concept diagram showing the configuration of the bubble according to an embodiment of the present disclosure;

FIG. 2 is a cross-sectional view showing control performed to switch between positive and negative voltages applied to an electrode unit while varying the frequency in a state in which the electrode is immersed in water containing the bubbles of FIG. 1;

FIG. 3 is a graph of the behavior of bubbles when the positive/negative switching period of the voltage applied to the electrode unit in FIG. 2 is changed;

FIG. 4 is a control block diagram of the configuration of a bubble control device for controlling the bubble in FIG. 1;

FIG. 5 is a graph of the behavior of bubbles when the zeta potential shown in FIG. 3 is set to less than 20 mV;

FIG. 6 is a graph of the behavior of bubbles when the zeta potential shown in FIG. 3 is set to less than 25 mV;

FIG. 7 is a flowchart showing the processing flow of the bubble control method of the present disclosure;

FIG. 8 is a graph of a comparative example showing the behavior of bubbles having a large positive zeta potential (30 to 40 mV) when the positive/negative switching period of the voltage applied from the voltage application unit to the electrode unit is changed;

FIG. 9 is a graph of a comparative example showing the behavior of bubbles having a large negative zeta potential (−30 to −40 mV) when the positive/negative switching period of the voltage applied from the voltage application unit to the electrode unit is changed; and

FIG. 10 is a graph of the relation between the circulation time for generating nanobubbles and the zeta potential of the generated nanobubbles.

### DESCRIPTION OF THE EMBODIMENTS

Embodiments will now be described in detail with reference to the drawings as needed. However, some unnecessarily detailed description may be omitted. For example, detailed description of already known facts or redundant description of components that are substantially the same may be omitted. This is to avoid unnecessary repetition in the following description, and facilitate an understanding on the part of a person skilled in the art.

The applicant has provided the appended drawings and the following description so that a person skilled in the art might fully understand this disclosure, but does not intend for these to limit what is discussed in the patent claims.

### Embodiment 1

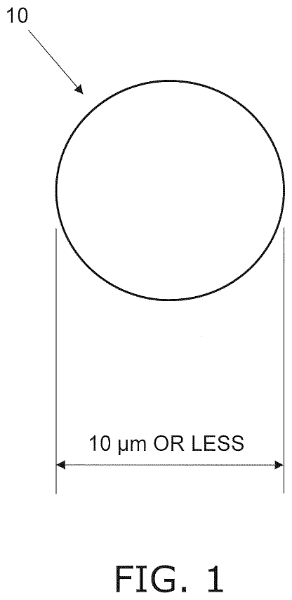

A bubble 10 and a bubble control device 20 according to an embodiment of the present disclosure will now be described with reference to FIGS. 1 to 7 and 10.

The bubbles 10 according to this embodiment are, for example, electrically charged bubbles contained in water, and include, for example, microbubbles having a diameter of 10 μm or less, micro-nanobubbles (diameter of about several hundred nm to 10 μm), or nanobubbles (diameter of about several hundred nm or less) as shown in FIG. 1. The bubbles 10 go through processes of “rising,” “contracting,” and “collapsing” in water, pop within several hours to several weeks, and provide an effect suited to the intended use, such as cleaning, sterilization, or deodorization.

The method for producing the bubbles 10 of this embodiment involves using, for example, a pump-type bubble generator that combines a pressurized dissolution method, a liquid flow shear method, etc. With these bubble generators, visible microbubbles and invisible nanobubbles are simultaneously mixed into the water flow that is sprayed out, so the system must be controlled so that the nanobubbles will be in the optimal state.

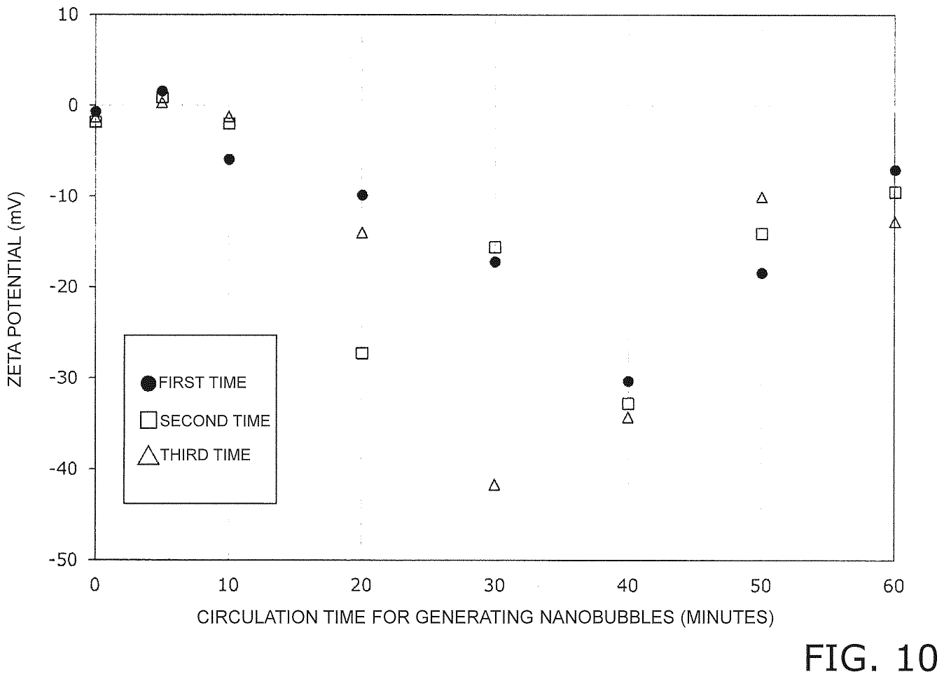

FIG. 10 shows an example of generating nanobubble water with a controlled zeta potential by pumping up the sprayed water flow again (the water is left to stand until the microbubbles disappear). As shown in FIG. 10, in this example, if the water circulation time is less than 10 minutes, nanobubbles with a positive zeta potential are generated/remain, and if the time is 10 minutes or more, nanobubbles with a negative zeta potential are generated/remain.

In the drawings, the “first time,” “second time,” and “third time” mean that the same water has been circulated three times. Also, “circulation” refers to the general principle of pump circulation, in which water is pumped up from one outlet of a container and sprayed out from the other outlet of the container.

However, there are other methods for producing the bubble 10, and the production method is not limited to what is disclosed herein.

The bubble 10 in this embodiment has a positive zeta potential, for example, and in the method for controlling the bubbles 10 described below, when an electric field reversal test is performed in which the bubbles 10 are alternately attracted to an anode and a cathode, if the positive/negative switching period of the voltage applied to the electrode unit 21 is changed from fast reversal (high frequency range) to slow reversal (low frequency range), the bubbles will exhibit behavior as if they were bubbles with a negative potential.

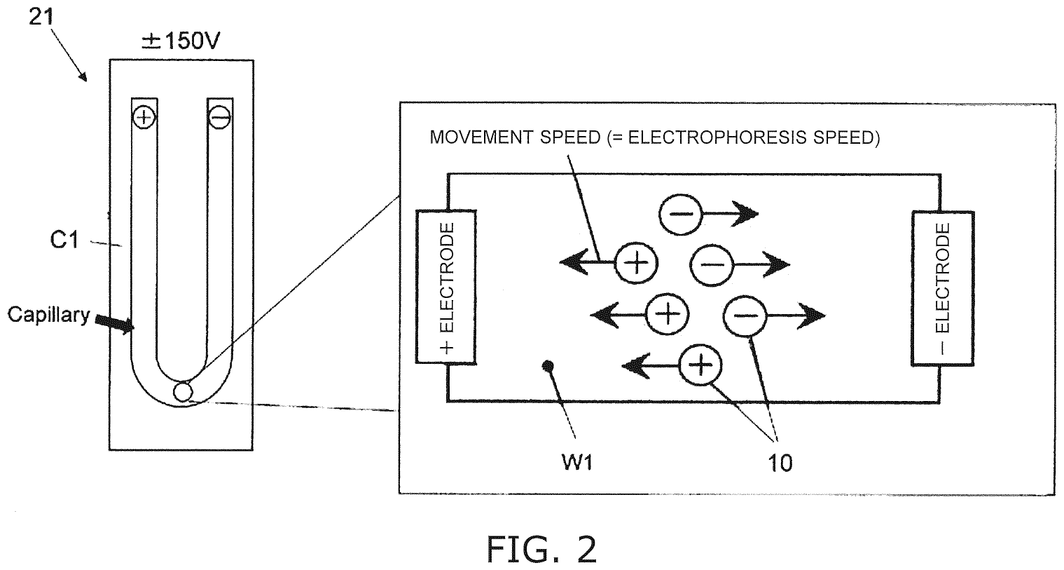

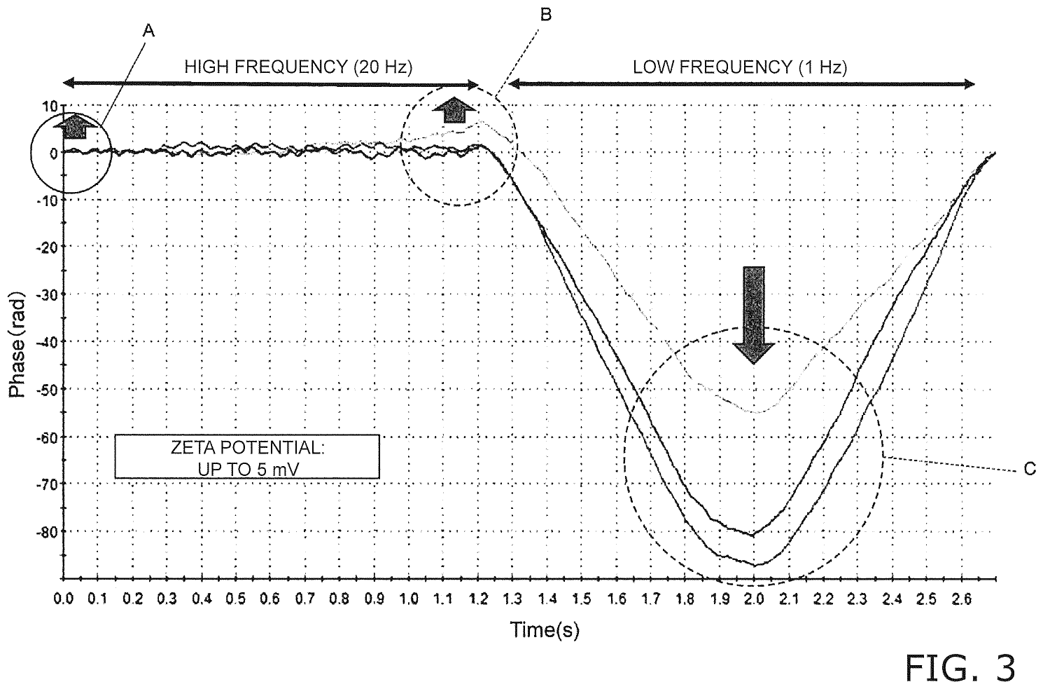

That is, in this embodiment, as shown in FIG. 2, when an electric field reversal test is performed in which a tube is filled with water (bubble water) W1 containing the bubbles 10 and alternating positive/negative voltages are applied to a positive/negative electrode unit 21 (see FIG. 2) connected by a tube so as to attract the bubbles, the phase shift between the incident light emitted to measure the potential of the bubbles 10 and the scattered light scattered by the bubbles 10 responds to the opposite sign (from + to −) between slow field reversal and fast field reversal, in which the reversal occurs in a shorter period than with slow field reversal (see FIG. 3).

In other words, the bubbles 10 have an electrostatic property that can reverse charge by switching the frequency of the electric field reversal using the water W1 containing the bubbles 10.

More precisely, even though the bubbles 10 have a positive zeta potential (such as 5 mV), when the positive/negative switching period of the voltage applied to electrode unit 21 changes from a fast reversal (high frequency range) to a slow reversal (low frequency range) in an electric field reversal test, the bubbles exhibit behavior as if they were bubbles with a negative potential that are attracted to the electrode on the positive side.

Here, the method for measuring the behavior of the bubbles 10 can be, for example, to use a dynamic light scattering (DLS) analysis device with zeta potential analyzer.

More specifically, positive/negative voltages are applied alternately to the electrode unit 21 in a state in which the electrode unit 21 (see FIG. 2) is immersed in water (bubble water) W1 containing the bubbles 10. The mobility and direction of the bubbles 10 are then measured from the phase shift between the incident light emitted to measure the potential of the bubbles 10 and the scattered light that strikes the bubbles 10 and is scattered.

With dynamic light scattering (DLS), particles undergoing Brownian motion are irradiated with a laser beam, and the scattered light signal at a certain angle is detected. The scattered light is analyzed as the change in frequency or the intensity (fluctuation) of light corresponding to particle size, and frequency analysis is performed in the frequency range of 1 Hz to 100 KHz.

The size of the bubbles 10 is calculated using the following Stokes-Einstein equation. The diffusion coefficient D is determined by analysis of the autocorrelation function.

$${D}_{H} = \frac{kT}{3 πη D} \qquad Mathematical Formula 1$$

(Where D_{H} is the hydrodynamic diameter, D is the diffusion coefficient, k is the Boltzmann constant, T is the temperature (K), and η is the viscosity.)

Thus, dynamic light scattering (DLS) with zeta potential analyzer is a technique for measuring with high precision the fine particles contained in a suspension or emulsion, and particle diameters of just a few microns, zeta potential, and molecular weight, for example, can be measured on the basis of Brownian motion (small particles move quickly and large particles move slowly).

Other techniques that can be used include particle trajectory analysis, laser diffraction/scattering, electrical detection zone method, resonance mass measurement, and dynamic image analysis.

The zeta potential of the bubbles 10 can be measured, for example, by electrophoresis. In electrophoresis, when an electric field is applied to charged particles suspended in an electrolyte, the charged particles move at a constant speed toward an electrode having the opposite polarity from that of the surface charge, and this allows the zeta potential of the bubbles to be measured by applying the following Henry's equation. The mobility of the charged particles is determined by Doppler shift.

$${U}_{E} = \frac{2 ε z F ( ka )}{3 η} \qquad Mathematical Formula 2$$

(Where U_{E} is the electrophoretic mobility, z is the zeta potential, F is the dielectric constant, η is the viscosity, and F(ka) is the Henry's constant.)

The water containing the bubbles 10 has a pH in the range of 5.0 to 7.0, and distilled water, pure water, or the like can be used.

Consequently, there is no need to add chemicals such as surfactants to adjust the pH in order to prepare the water containing the bubbles 10 in this embodiment.

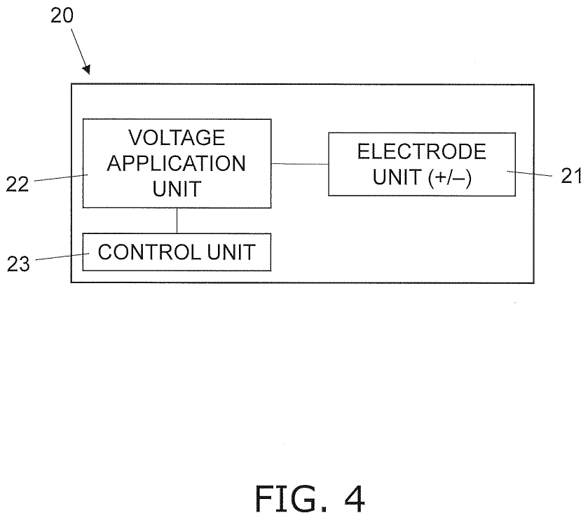

In this embodiment, in an electric field reversal test performed to verify the characteristics of the bubbles 10 mentioned above, the bubble control device 20 (see FIG. 4) applies a specific voltage to the electrode unit 21 in a state in which the electrode unit 21 is immersed in the water W1 containing the bubble 10 inside the container C1, as shown in FIG. 2.

As shown in FIG. 4, the bubble control device 20 comprises an electrode unit 21, a voltage application unit 22, and a control unit (voltage application control unit) 23.

As shown in FIG. 2, the electrode unit 21 is used in a state of being immersed in the water W1 containing the bubbles 10 inside the container C1, and a specific voltage is applied from the voltage application unit 22.

The voltage application unit 22 is connected to the control unit 23 and applies a specific voltage to the electrode unit 21.

The control unit 23 controls the voltage application unit 22 so as to apply a maximum voltage of 150 V to the electrode unit 21 while alternating between positive and negative signs in a specific cycle.

In the bubble control device 20, when the control unit 23 controls the voltage application unit 22 to apply a specific voltage to the electrode unit 21, because the bubbles 10 contained in the water W1 have a positive zeta potential, they are attracted to the electrode to which a negative voltage is applied.

At this point, as shown in FIG. 3, a specific voltage (maximum ±150 V) is applied to the electrode unit 21 in a high frequency region (0.0 to 1.2 seconds) in which the sign of the applied voltage is rapidly reversed, and in a low frequency region (1.3 s or more) in which the sign of the applied voltage is reversed at a lower frequency than in the high frequency region.

In the graph of FIG. 3, the horizontal axis is the elapsed time (seconds) from when voltage was applied to the electrode unit 21, and the vertical axis is the mobility (phase (rad)) of the bubbles 10 moving by electrophoresis in the water W1. The graph of FIG. 3 also shows data from three consecutive measurements of the behavior of the bubbles 10.

As shown in FIG. 3, in the high frequency region, the voltage is alternately applied between positive and negative at a frequency of, for example, 20 Hz for 1.2 seconds from the start of application of the voltage to the electrode unit 21. The period (first period) of the voltage applied in the high frequency region is preferably in the range of 10 to 40 Hz.

At this point, since the voltage applied to the electrode unit 21 is rapidly switched between positive, the bubbles 10 exhibit behavior such that they shake in small amounts between the anode side and cathode side of the electrode unit 21.

As shown in FIG. 3, in the low-frequency region, after 1.3 seconds has elapsed since the application of voltage to the electrode unit 21 was started, the applied voltage is alternately switched between positive and negative at a frequency of 1.0 Hz, for example. The period (second period) of the voltage applied in the low frequency region is preferably in the range of 0.01 to 2.0 Hz.

At this point, since the positive/negative switching of the voltage applied to the electrode unit 21 is slower than in the high frequency region, the bubbles 10 having a positive zeta potential exhibit behavior as if they were slowly attracted and moving toward the cathode side of the electrode unit 21.

In the experimental data shown in FIG. 3, the bubbles 10 respond like positively charged bubbles immediately after voltage application or in the rest region where the high frequency region is switched to the low frequency region (see portions A and B in FIG. 3). Here, “respond like positively charged bubbles” is defined as “exhibit a response (mobility) like that of positively charged bubbles” when the bubbles 10 are attracted to the electrode on the negative side shown in FIG. 2.

On the other hand, when the bubbles 10 move from the high frequency region (20 Hz) to the low frequency region (1 Hz), as shown in FIG. 3, those with a positive zeta potential exhibit behavior as if they were bubbles with a negative potential (see portion C in FIG. 3).

That is, as shown in FIG. 3, when the bubbles 10 move from the high frequency region (0 to 1.175 seconds), through a rest region (1.175 to 1.2 seconds) of approximately 0.1 second, to the low frequency region (1.2 seconds and above), they exhibit behavior as if they were bubbles with the opposite sign from that in the high frequency region (negatively charged bubbles), and are strongly attracted toward the electrode on the positive side.

In this embodiment, as described above, when the frequency of the electric field reversal is switched from the high frequency region to the low frequency region, the bubbles 10 behave as if their positive or negative sign had been reversed. When the frequency of the electric field reversal is switched from the low frequency region to the high frequency region, the bubbles 10 behave as if they were positively charged bubbles again. That is, the bubbles 10 reversibly respond to the opposite sign side upon undergoing repeated slow and fast reversals.

This reversible behavior means, for example, behavior in which a plurality of (three) pieces of data start from the same position and converge to the same position in the plurality of (three) experiments shown in FIG. 3.

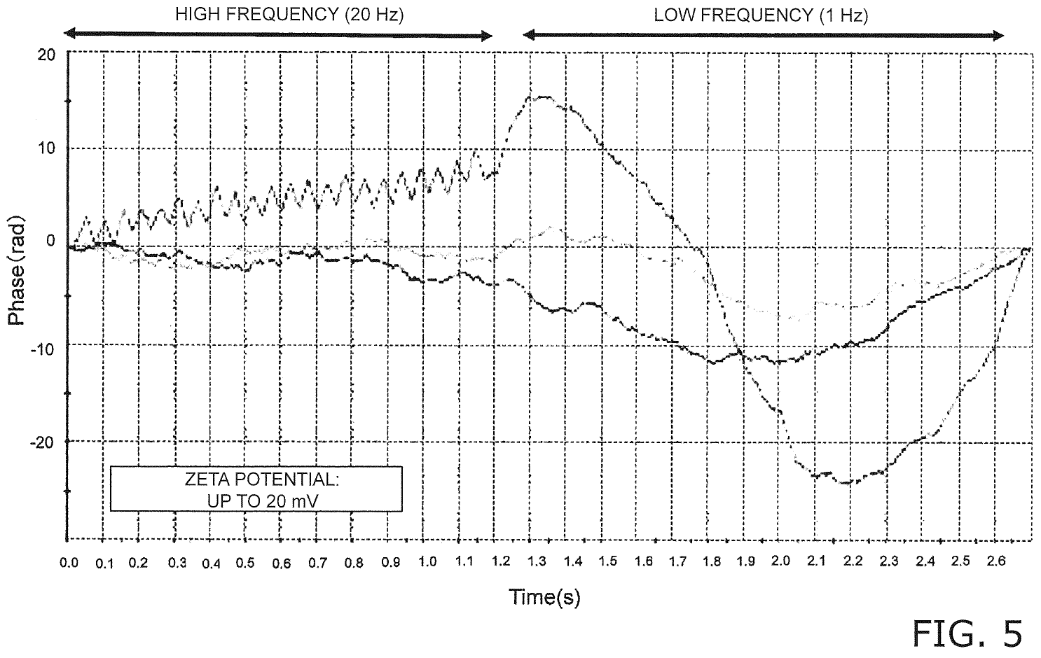

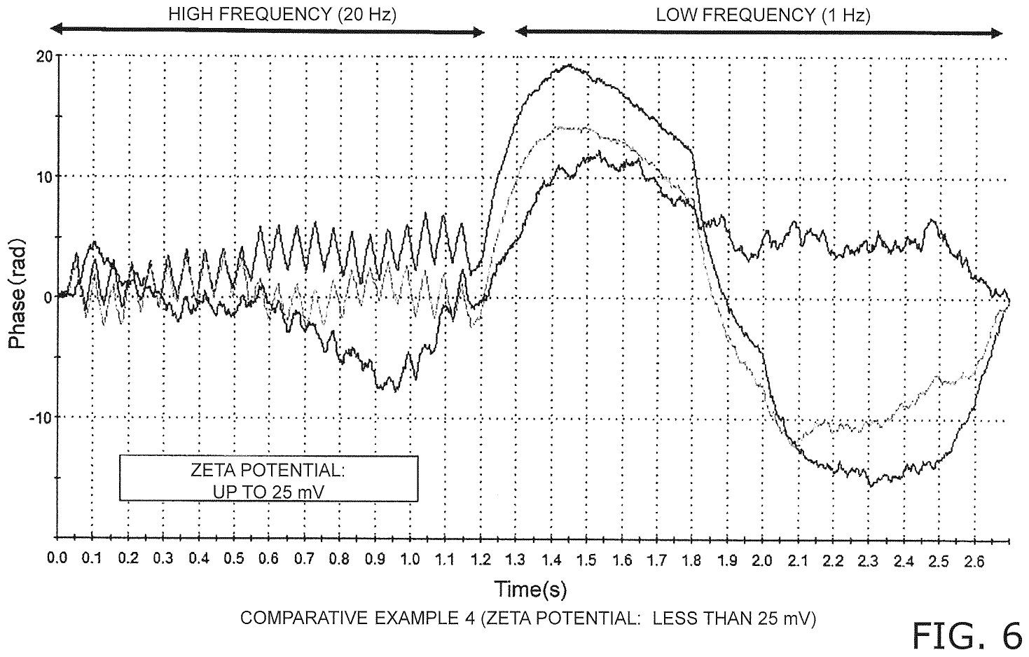

FIGS. 5 and 6 show the results of three similar experiments performed on bubbles with a larger zeta potential (about 20 mV or about 25 mV) than that in FIG. 3.

As shown in FIG. 5, even with bubbles having a zeta potential of about 20 mV, they behave like positively charged bubbles immediately after the start of voltage application in the high frequency region and immediately after the rest region in which the high frequency region is switched to the low frequency region, just as in FIG. 3. When the region then goes from the rest region to the low frequency region, the bubbles behave like negatively charged bubbles with the sign reversed, albeit somewhat later than in FIG. 3.

As shown in FIG. 6, even with bubbles having a zeta potential of about 25 mV, they behave like positively charged bubbles immediately after the start of voltage application in the high frequency region and in the rest region in which the high frequency region is switched to the low frequency region, as in FIG. 3. When the region changes to the low frequency region, the bubbles behave like negatively charged bubbles with the opposite sign, albeit somewhat later than in FIG. 3.

In this embodiment, as described above, when period of switching the sign of the voltage applied to the electrode unit 21 immersed in the water W1 containing the bubbles 10 is switched from the high frequency region (fast reversal) to the low frequency region (slow reversal) for bubbles 10 having a positive zeta potential, the bubbles 10 behave like positively charged bubbles in the high frequency region and like negatively charged bubbles in the low frequency region.

That is, as shown in FIG. 3, the bubbles 10 of this embodiment behave like electrically charged bubbles with opposite signs in the high frequency region (0.0 to 1.2 seconds) in which the sign of the applied voltage is rapidly reversed, and in the low frequency region (1.3 seconds and above) in which the sign of the applied voltage is reversed at a frequency lower than the high frequency region.

Consequently, when the goal is to gather the bubbles 10 to the desired location, for example, the behavior of the bubbles 10 can be controlled by switching the positive and negative switching frequency of the applied voltage between a high frequency and a low frequency.

Also, in this embodiment, there is no need to add any surfactants or other such chemical substances to normal water W1 (pH 5.0 to 7.0), and the responsiveness of the charged bubbles 10 can be switched, which expands the scope of application.

### Method for Controlling Bubbles 10

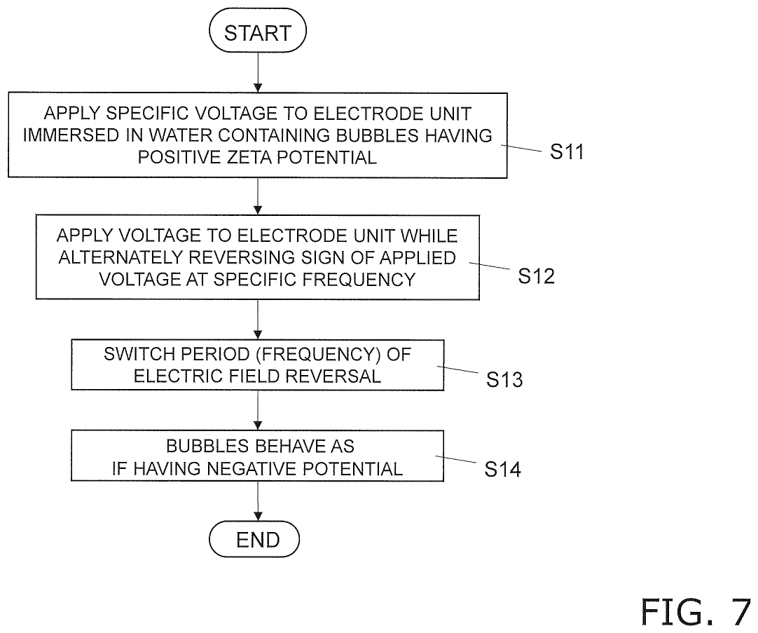

The method for controlling the bubbles 10 of this disclosure will now be described with reference to the flow chart shown in FIG. 7.

As shown in FIG. 7, first, in step S11, in the bubble control device 20, the control unit 23 controls the voltage application unit 22 so as to apply a specific voltage (±150 V) to the electrode unit 21 immersed in the water W1 containing the bubbles 10 having a positive zeta potential (voltage application step).

Next, in step S12, the control unit 23 controls the voltage application unit 22 so as to apply voltage to the electrode unit 21 while alternately reversing the sign (positive or negative) of the applied voltage at a specific frequency (electric field reversal) (alternating application step).

Consequently, the bubbles 10 near the electrode unit 21 move back and forth between the anode side and cathode side of the electrode unit 21.

Next, in step S13, the period of the electric field reversal applied in step S12 is switched from the high frequency region (about 20 Hz) to the low frequency region (1 Hz) (period switching step).

Next, in step S14, the period (frequency) of the electric field reversal in step S13 is switched to the low frequency region, the result being that the bubbles 10 in the water W1 behave as if they had a negative potential, despite having a positive zeta potential.

In the above description, the electric field reversal in the high frequency region and low frequency region was carried out as an experiment to check the characteristics of these bubbles, and the optimal frequency region for suitably controlling the bubbles is not limited by this.

### COMPARATIVE EXAMPLES

### Comparative Example 1

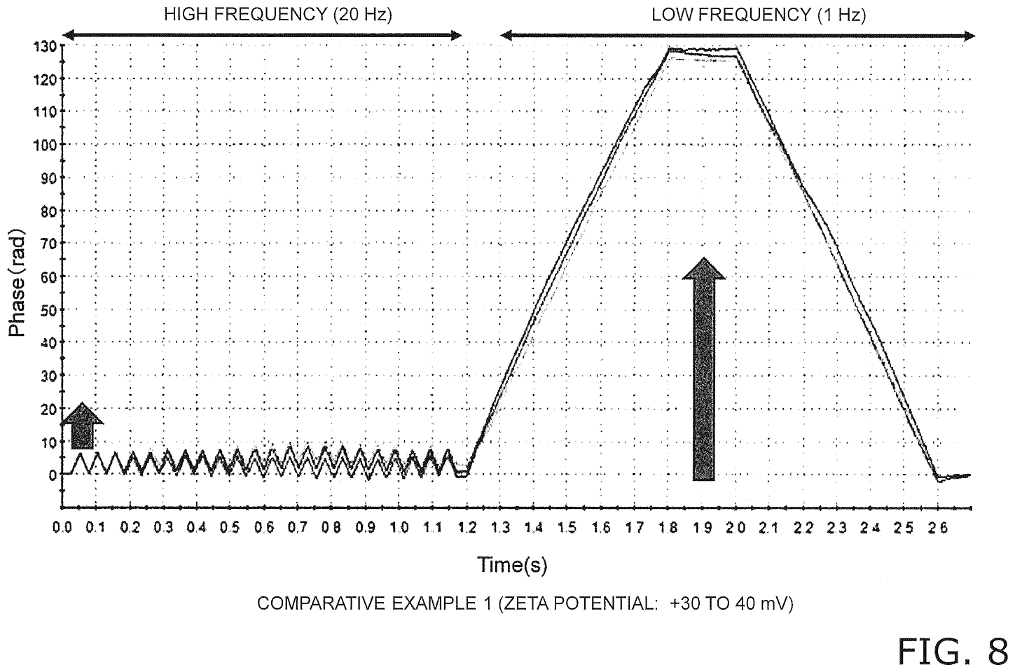

FIG. 8 shows the results of Comparative Example 1, in which the behavior of bubbles was measured when the above-mentioned charge reversal control was performed in a state in which the electrode unit was immersed in water containing bubbles having a relatively large zeta potential on the positive side (+30 to 40 mV).

In Comparative Example 1, as shown in FIG. 8, during the period up to 1.2 seconds after the start of the application of voltage to the electrode unit 21, in the high frequency region where the applied voltage is rapidly alternated between positive and negative at a frequency of 20 Hz, for example, the bubbles initially behave like positively charged bubbles, and exhibit behavior such that they shake in small amounts between the anode side and cathode side of the electrode unit 21.

Then, as shown in FIG. 8, once 1.3 seconds has elapsed since the start of the application of voltage to the electrode unit 21, in the low frequency region where the applied voltage is alternated between positive and negative at a slow speed, such as at a frequency of 1.0 Hz, the bubbles behave like positively charged bubbles that move slowly toward the cathode side, unlike the bubbles 10 of this embodiment shown in FIG. 3.

### Comparative Example 2

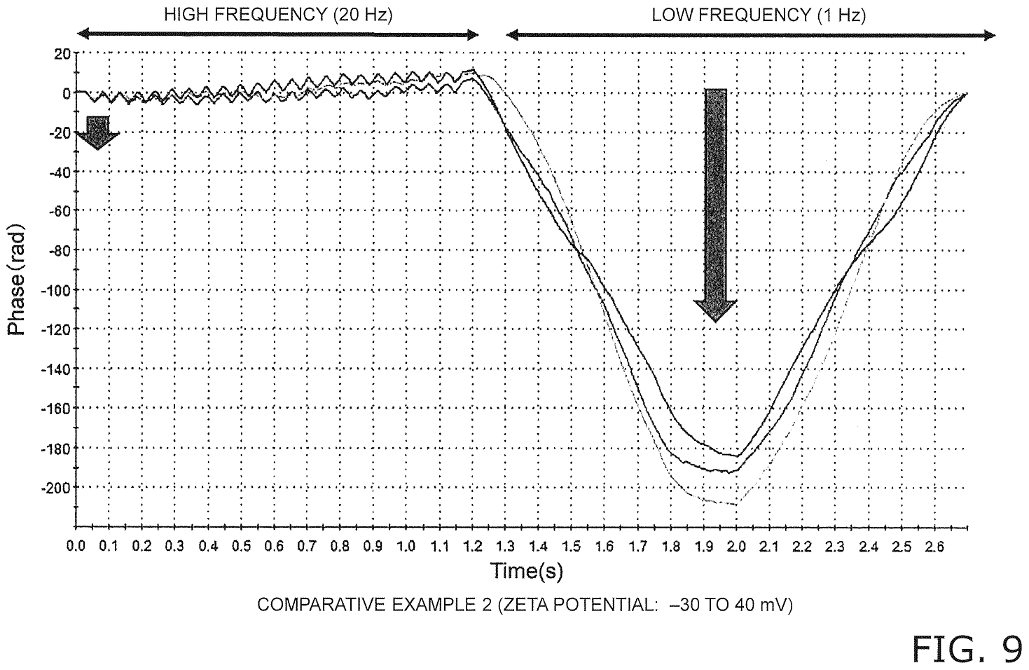

FIG. 9 shows the results of Comparative Example 2, in which the behavior of bubbles was measured when the above-mentioned charge reversal control was performed in a state in which the electrode unit was immersed in water containing bubbles having a relatively large zeta potential on the negative side (−30 to 40 mV).

In Comparative Example 2, as shown in FIG. 9, during the period up to 1.2 seconds after the start of the application of voltage to the electrode unit 21, in the high frequency region where the applied voltage is rapidly alternated between positive and negative at a frequency of 20 Hz, for example, the bubbles initially behave like negatively charged bubbles, and exhibit behavior such that they shake in small amounts between the anode side and cathode side of the electrode unit 21.

Then, as shown in FIG. 9, once 1.3 seconds has elapsed since the start of the application of voltage to the electrode unit 21, in the low frequency region where the applied voltage is alternated between positive and negative at a slow speed, such as at a frequency of 1.0 Hz, the bubbles behave like negatively charged bubbles that move slowly toward the anode side, unlike the bubbles 10 of this embodiment shown in FIG. 3.

As described above, it was found from the results of Comparative Examples 1 and 2 that when the absolute value of the zeta potential is large (up to 30 mV or more), if the electric field reversal period shown in FIG. 3 of this embodiment is switched, the bubbles will not behave like charged bubbles of the opposite sign, and will instead exhibit behavior from positive to positive, or negative to negative.

Consequently, in order to control the bubbles so that they behave like charged bubbles of the opposite sign when the electric field reversal period is switched, it is preferable for the zeta potential of the bubbles to be less than 30 mV, and more preferably in the range of 5 to 25 mV, as discussed above (see FIGS. 3, 5, and 6).

That is, as shown in FIG. 6, if the zeta potential of the bubbles is less than 25 mV, the bubbles can be controlled to behave like charged bubbles of the opposite sign when the electric field reversal period is switched. On the other hand, as shown in FIG. 8, if the zeta potential of the bubbles is 30 mV or more, the bubbles will not behave like charged bubbles of the opposite sign even though the electric field reversal period is switched.

Consequently, the condition for utilizing the bubble behavior by reversing it between positive and negative is for the voltage to be less than 30 mV.

### OTHER EMBODIMENTS

An embodiment of the present disclosure was described above, but the present disclosure is not limited to or by the above embodiment, and various modifications are possible without departing from the gist of the disclosure.

(A)

In the above embodiment, the bubbles 10 were present in the water in the form of individual bubbles. However, the present disclosure is not limited to this.

For instance, the bubbles may be in the form of an aggregate of a plurality of bubbles joined together in the water.

Here again, controlling the bubbles under the above conditions affords the same effect as the effect obtained in the above embodiment, even in the case of a bubble aggregate in which a plurality of bubbles are joined together.

(B)

In the above embodiment, an example was given in which the electric field reversal control was performed so that the voltage applied to the electrode unit 21 was alternately switched between positive and negative at a frequency of 20 Hz in the high frequency region (fast reversal) and 1 Hz in the low frequency region (slow reversal). However, the present disclosure is not limited to this.

For example, the switching of voltage in the high frequency region and the low frequency region is not limited to the above frequencies, and the switching between positive and negative may be performed at a high frequency other than 20 Hz or a low frequency other than 1 Hz.

(C)

In the above embodiment, an example was given in which the bubble control method involved showing the results of verifying the behavior of the bubbles 10 when switching from a high frequency region (high speed reversal) to a low frequency region (low speed reversal). However, the present disclosure is not limited to this.

For example, the bubble control method may be one in which the period of the electric field reversal is switched from a low frequency region (slow reversal) to a high frequency region (fast reversal).

Here again, the bubbles behave like charged bubbles with the opposite sign upon switching from the low frequency region (slow reversal) to the high frequency region (fast reversal).

(D)

In the above embodiment, an example was given in which the bubbles 10 having a positive zeta potential behaved like bubbles charged with the opposite sign (negative) when switching from a high frequency region (fast reversal) to a low frequency region (slow reversal), but the present disclosure is not limited to this.

For example, bubbles with a negative zeta potential may be controlled so as to behave like positively charged bubbles when the period (frequency) of the electric field reversal is switched.

### INDUSTRIAL APPLICABILITY

The bubbles of the present disclosure exhibit the effect that the responsiveness of charged bubbles can be switched without having to add any chemical substances, etc., and therefore can be broadly applied to water, gas, etc., that contain bubbles.

### REFERENCE SIGNS LIST

10 bubble
20 bubble control device
21 electrode unit
22 voltage application unit
23 control unit (voltage application control unit)
C1 container
W1 water (bubble water)

1. A bubble,
wherein, when an electric field reversal test is performed using water containing the bubble, in which the bubble is alternately attracted to an anode and a cathode, the bubble exhibits a behavior in which the bubble has charges of opposite signs between a slow field reversal and a fast field reversal in which the electric field is reversed in a shorter period than in the slow field reversal.

2. The bubble as in claim 1,
wherein the bubble has a positive zeta potential, and exhibits a behavior in which when there is a transition from fast field reversal to slow field reversal, the potential is negative.

3. The bubble as in claim 1,
wherein a diameter is 10 μm or less.

4. The bubble as in claim 1,
wherein the water has a pH in a range of 5.0 to 7.0.

5. The bubble as in claim 1,
wherein the slow field reversal is 0.01 to 2.0 Hz, and
the fast filed reversal is 10 to 40 Hz.

6. The bubble as in claim 1,
wherein when the slow field reversal and the fast field reversal are repeated, there is a reversible response to a side of the opposite sign.

7. A bubble,
having an electrostatic property that reverses charge, by switching a frequency of an electric field reversal using water containing the bubble.
bubble.

8. A bubble aggregate,
comprising a plurality of the bubbles as in claim 1.

9. Bubble water,
containing the bubble as in claim 1.

10. A device for controlling the bubble as in claim 1, the device comprising:
an electrode unit including an anode and a cathode that are inserted into water containing the bubble;
a voltage application unit configured to apply a specific voltage to the electrode unit; and
a voltage application control unit configured to control the voltage application unit so as to apply voltage alternately to the anode and the cathode, thereby alternately attracting the bubble to the anode and the cathode, and switch a period of electric field reversal that alternately attracts the bubble to the anode and the cathode from a first period to a second period that is different from the first period.

11. A method for controlling the bubble as in claim 1, comprising:
a voltage application step of applying a specific voltage to an electrode unit including an anode and a cathode that are inserted into water containing the bubble;
an alternating application step of alternately applying voltage to the anode and the cathode to alternately attract the bubble to the anode and the cathode; and
a period switching step of switching the period of electric field reversal that alternately attracts the bubble to the anode and the cathode from a first period to a second period that is different from the first period.
